(19) United States
(12) Patent Application Publication
(10) Pub. No.: US 2010/0051348 A1
(43) Pub. Date: Mar. 4, 2010

(54) ROCK DRILLING EQUIPMENT AND A METHOD IN ASSOCIATION WITH SAME

(76) Inventor: Kurt Andersson, Tyreso (SE)

Correspondence Address: Mark P Stone, 25 Third Street 4th Floor, Stamford, CT, 06905, US

(21) Appl. No.: 12/448,337

(22) PCT Filed: Jan. 10, 2008
(86) PCT No.: PCT/SE2008/000014

§ 371 Date: Jun. 17, 2009

(30) Foreign Application Priority Data
Jan. 11, 2007 (SE) 0700063-1

(51) Int. Cl. E21B 1/24; E21B 1/38; E21B 1/26; B25D 9/00

(52) U.S. Cl. 175/57; 175/135; 173/128; 173/1

(57) ABSTRACT

A rock drilling machine with a first control means (21, 22) within a second piston (6) and acting on a first piston (13) such that it counteracts displacement of the relative positions of a first and a second control device at the moment of contact of the second piston onto the drill rod or onto a part (9) connected to this. Furthermore, a rock drill rig comprising such a rock drilling machine and a method for counteracting the said displacement. Significant improvements in reproducibility for impact mechanism stability over long manufacturing series are achieved through the invention. In the same way, the lifetime of rock drilling devices manufactured according to the invention is extended through the impact mechanism acting in a more stable manner despite wear of component parts. It is furthermore possible to dimension for higher rates of impact without risking the impact mechanism stability.

### TECHNICAL FIELD

The present invention concerns a rock drilling machine that has a control device in order to control, while in use, a change over in the pressure of a fluid acting on a piston that repeatedly impacts upon a drill rod connected to the drilling machine. It refers also to a drill rig with such a machine mounted and a method intended to be in use within such a drilling machine.

### BACKGROUND

Rock drilling devices of the type described here, intended for drilling in rock, are fluid driven, most often hydraulically. An example of a rock drilling device according to such prior art technology is illustrated schematically in FIG. 1. The drilling device 1 can be connected to a fluid container, such as a tank 2 of hydraulic liquid. A pump 3 is used to create a source of hydraulic liquid under high pressure. A slide valve 4 controls, in interaction with control devices in a piston housing 7 and on the hammer piston 6, the hydraulic liquid such that at least one driving surface 5 of the hammer piston that runs in a piston housing in the drilling device is subject alternately to high pressure and to low pressure.

The hammer piston 6 is arranged such that it impacts at its forward end, the piston tip 8, onto the shank 10 of a drill adapter 9. A drill rod can be connected to the drill adapter 9 for the intended drilling into a surface to be drilled, such as into rock. Several drill rods can be connected together to form a drill string of such a length that the desired depth of drilling can be achieved. A control conduit 11a is present in the piston housing 7, which control conduit is arranged in connection with the source 3 of hydraulic liquid. This control conduit 11a interacts with a control chamber 12 formed between the hammer piston 6 and the piston housing 7, whereby the slide 4 can be controlled depending on the position of the hammer piston 6 in the axial direction relative to the piston housing 7. A conduit 11b exerts constant pressure onto a control edge of the hammer piston 6 for driving the piston backwards.

In order to maintain the drill rod in constant contact with the surface to be drilled and in order to maintain the parts of the drill string in constant contact with each other, a recoil damper, with a recoil piston 13 included, is arranged. This recoil piston 13 is normally arranged concentrically around the front part of the hammer piston 6. The recoil piston 13 is held pressed against the shank 10 of the drill adapter 9 by means of hydraulic liquid from a pressure conduit 14 that is arranged in contact with a high-pressure source through a constant-flow valve, such that the hammer piston 6 can impact against a non-elastic surface when it impacts onto the shank of the drill adapter.

The complete drilling device is pressed during drilling against the object to be drilled with a feed force. The feed force can be applied, for example, hydraulically in a drill rig, which is an equipment for setting the position and angle of one or several drilling devices while drilling. The drilling device is then often mounted on a carriage that can be displaced along a feed beam in the drill rig. If the feed force becomes greater than the recoil pressure, i.e. the product of the pressure in the liquid that drives the damper piston forward in the direction of drilling and the cross-sectional area of the recoil piston, or—to be more accurate—the driving surface of the recoil piston on which the liquid acts, then the recoil piston will be pressed backwards. In order to counteract this and to achieve as far as possible constant conditions when the hammer piston impacts onto the drilling steel or the shank adapter, a drainage conduit or balance conduit 16 has been arranged, which functions as described below.

Instead of the recoil piston 13 making direct contact with the shank 10 of the drill adapter 9, a bushing 15 can be placed in the damper between the recoil piston 13 and the shank 10 of the drill adapter 9, as is shown in, for example, the document U.S. Pat. No. 5,479,996. The recoil piston 13 has an additional function, which is that of absorbing recoil forces from the surface to be drilled when the drill steel is pressed against this surface with the impact force that is transmitted from the hammer piston 6. The recoil piston 13 absorbs the pressure that is transmitted back from the surface to be drilled hydraulically, and thus it oscillates in the axial direction controlled by the pressures to which is subject from hydraulic liquid and from the recoil forces from the drill steel. The recoil piston 13 is for this reason provided with a drive chamber 14b formed between the recoil piston and the piston housing. This drive chamber is limited by at least one forward driving surface 13b in the recoil piston. The drive chamber 14b is drained through a balance conduit 16 in the piston housing 7 when the recoil piston reaches a position that is sufficiently far forward. If the recoil piston 13 is driven backwards, such that the driving surface 13b becomes located behind the balance conduit 16, then the pressure in the drive chamber 14b will rise, whereby the pressure on the driving surface 13b entails the recoil piston 13 being driven forwards. If, on the other hand, the recoil piston 13 is driven forwards such that the driving surface 13b frees the opening of the balance conduit 16 with respect to the drive chamber 14b, then the drive chamber will be drained through the balance conduit 16, whereby the pressure in the drive chamber will 14b fall, which in turn entails the piston being pressed backwards. The recoil piston will in this way take up a position that balances around the point at which the driving surface 13b of the recoil piston opens the drive chamber 14b for the balance conduit 16.

One problem with the technology described above is that the function of the impact mechanism tends to be unstable in some devices, particularly when dimensioning for high rates of impact, and particularly after a certain period of operation.

### OBJECT OF THE INVENTION AND ITS PRINCIPAL CHARACTERISTICS

One object of the present invention is to achieve a method to reduce the above-mentioned problems with the prior art technology.

It has been shown that significant improvements in the repeatability of impact mechanism stability for long manufacturing series of rock drilling devices can be achieved with the invention. In the same way, the lifetime of rock drilling devices manufactured according to the invention is extended through the impact mechanism acting in a more stable manner despite wear of component parts. It is furthermore possible to dimension for higher rates of impact without risking the impact mechanism stability.

According to a first aspect of the invention, an arrangement is presented as it is specified in the independent apparatus claims.

According to a second aspect of the invention, a method is presented as it is specified in the independent method claim.

Further preferred embodiments and aspects of the invention are disclosed in the dependent claims.

According to the invention, instead of, as has been done up until now, allowing the drive chamber 14b of the recoil piston 13 to be drained when the recoil piston has reached a pre-determined position relative to the piston housing, this drainage will take place when the hammer piston 6 is located at a pre-determined position relative to the piston housing. Since the control devices for the forwards/backwards change-over of the percussion arrangement are located on the hammer piston and in the piston housing, respectively, the relative position of these control devices will come under better control in the instant at which the hammer piston impacts on the drilling shank. In particular, the relative position at this instant will become independent of a number of manufacturing tolerances. In the same way, sensitivity to wear of component parts, such as the piston tip, the shank and the recoil piston, will be reduced. An improved impact mechanism stability with time, for long manufacturing series and at increasing rates of impact is achieved in this manner.

### BRIEF DESCRIPTION OF THE DRAWINGS

FIG. 1 shows schematically a longitudinal cross-section through a hydraulic rock drilling device according to the prior art technology.

FIG. 2 shows schematically a corresponding longitudinal cross-section through a hydraulic rock drilling device according to the invention.

FIG. 3 shows schematically a partial enlargement of control devices that ensure the change over of the pressure required to achieve the repetitive impacts by means of the hammer piston according to the prior art technology.

FIG. 4 shows schematically an enlargement of the region A of FIG. 2 and illustrates more clearly the function of control means according to an embodiment of the inventive concept.

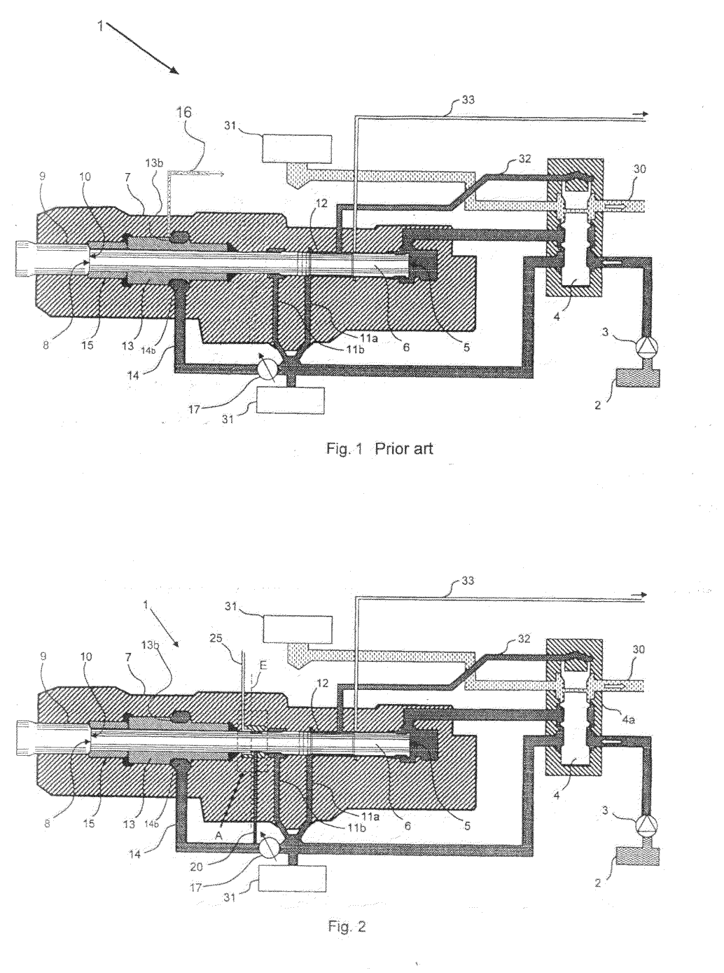

### DETAILED DESCRIPTION OF PREFERRED EMBODIMENTS

A number of embodiments of the invention will be described below, supported by the attached drawings, in order to provide examples. The invention is not limited to the embodiments described: it is determined by the scope defined by the claims.

FIG. 2 shows an example of a hydraulic rock drilling device 1 according to one aspect of the invention. The drilling device 1 can be connected to a fluid container, such as a tank 2 of hydraulic liquid. A pump 3 is used to create a source of hydraulic liquid under high pressure. Furthermore, a second piston 6, known as the “hammer piston”, is part of the device, running in the axial direction in a piston housing 7, which constitutes at the same time the device housing of the drilling device. A slide 4, located in a slide housing 4a, in interaction with control devices (12, 11a, 33, 32), controls a hydraulic liquid such that at least one driving surface 5 of the second piston 6 is subject to a change-over of the pressure, i.e. alternation between high and low pressure.

The second piston 6 is according to the prior art technology arranged such that, when in use, it provides repetitive impacts at its forward end, the piston tip 8, onto the shank 10 of a drill adapter 9. The drill adapter 9 is mounted in bearings in the piston housing 7 and it is aligned with the second piston 6. Thus the drill adapter 9 and the second piston 6 lie along the same axis. A drill rod can be connected to the drill adapter 9, or a drill string having several connected drill rods, for the intended drilling into a surface to be drilled, such as into rock. First control device, in the form of a control conduit 11a, a slide signal line 32 and a drainage conduit 33, are present in the piston housing 7. The control conduit 11a is in contact with the source 3 of hydraulic liquid. A second control device is constituted by a control chamber 12 formed between the second piston 6 and the piston housing 7, preferably in the form of an annular groove in the piston 6. The slide 4 can be controlled in dependence of the position in the axial direction of the second piston 6 relative to the piston housing 7, by influence of the pressure in the slide signal line 32.

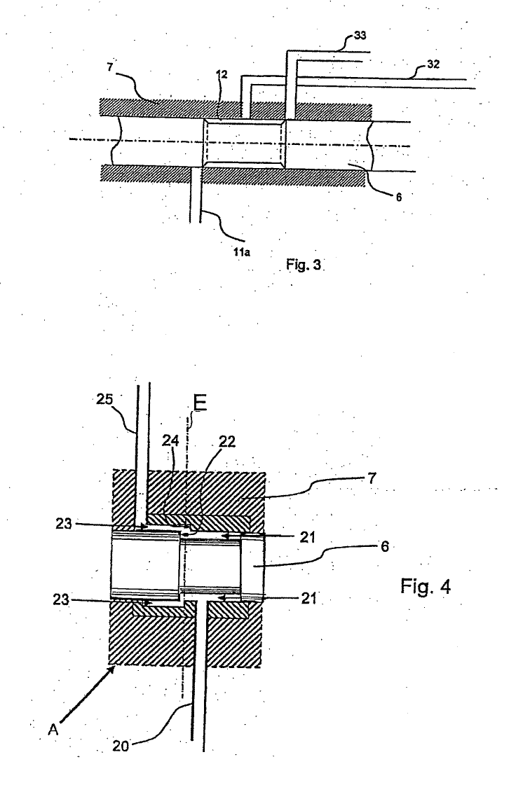

The control of the change-over of the pressure will be illustrated with reference to FIG. 3. It can be seen in this drawing that when the second piston 6 moves to the right, the pressure in the control chamber 12 will rise to the pressure at the level of pressure of the hydraulic liquid from the source 3. An outlet is hereby opened from the control chamber 12 to the drainage line 33, whereby the pressure in the control chamber falls to the drainage level. The change in the pressure in the control chamber 12 is transmitted through the slide signal line 32 and influences the slide 4, such that hydraulic liquid at high pressure influences the second piston through the driving surface 5 such that the second piston moves to the left in the drawing. The drainage line 33 will in this way be closed, while the control conduit 11a opens onto the control chamber 12 and it increases once again the pressure in this chamber. This in turn entails the pressure on the driving surface 5 at the end of the second piston 6 being removed through the action of the slide 4. The method is subsequently repeated according to the pattern described.

In order to maintain the drill steel in constant contact with the surface to be drilled and in order to maintain the parts of the drill string in constant contact under pressure with each other, a recoil damper is present including a recoil piston, a first piston, 13. This recoil piston 13 is normally arranged concentrically around the forward part of the second piston 6 (where the term “forward” in this description is used to denote the direction of drilling). The recoil piston 13 is held pressed against the shank 10 of the drill adapter 9 by means of hydraulic liquid from a pressure conduit 14 that is placed in contact with a high-pressure source 3 through a constant-flow valve 17, such that the second piston 6 can impact against a non-elastic surface when it impacts the shank 10 of the drill adapter 9.

Instead of the recoil piston 13 making direct contact with the shank 10 of the drill adapter 9, a bushing 15 can be placed in the damper between the recoil piston 13 and the shank 10 of the drill adapter 9. The recoil piston 13 has, as has been mentioned, an additional function, which is that of absorbing recoil forces from the surface to be drilled when the drill bit is pressed against this surface with the impact force that is transmitted from the second piston 6. The recoil piston 13 absorbs hydraulically the force that is transmitted back from the surface to be drilled, and thus it oscillates in the axial direction controlled by the pressures to which it is subject from hydraulic liquid and from recoil forces from the drill steel. The recoil piston 13 is for this reason provided with a drive chamber 14b formed between the recoil piston 13 and the piston housing 7. The drive chamber is limited by at least one forward driving surface 13b in the recoil piston. The drive chamber 14b is drained when the hammer piston 6 reaches a position sufficiently far forwards in the piston housing 7 through a first control means 21, 22 located in a second piston 6 (the hammer piston) and a second control means 20, 23, 24, 25 located in the piston housing 7. The function is made clear in more detail in FIG. 4, which is a partial enlargement of A in FIG. 2.

The second control means includes an adjustment conduit 20 that is in connection with the pressure conduit 14 that is connected to the drive chamber 14b of the recoil piston and that opens out into the cylinder bore in the piston housing. When the hammer piston 6 approaches the pre-determined location for the impact onto the shank 10, a first compartment 21 that is formed between the hammer piston and the piston housing and that belongs to the first control means will receive oil from the adjustment conduit 20. If the hammer piston reaches a position sufficiently far forwards that a first control edge 22 in the first control means passes a second control edge 24 that belongs to the second control means, then the oil from the drive chamber 14b will be drained onwards through a second compartment 23 formed between the hammer piston and the piston housing and belonging to the second control means, and subsequently through the drainage line 25. The recoil pressure will in this way be reduced and the feed force will drive the shank backwards until the drainage process ceases, the pressure in the drive chamber 14b again rises, and the drilling shank 10 is in this way driven again forwards. The shank 10 is thus balanced around a position E that is directly coupled with the actual position of the hammer piston.

Furthermore, a return conduit 30 for hydraulic liquid is shown in the drawings, which return conduit returns hydraulic liquid to the tank 2 through the slide 4. Gas accumulators 31 are located not only in the pressure conduit 14 but also in the return conduit 30 in order to even out pressure differences in the lines. It must also be emphasised here that the conduits for achieving the complete control are not fully illustrated in the drawings: they are illustrated only schematically, since this constitutes prior art technology and does not affect the invention.

The location of the position E is selected such that the desired length of travel is achieved. The second piston 6 is to move along a certain distance from its impact position before a point is passed at which the travel of the slide is reversed. When this occurs, the slide 4 starts to move and the pressure on the driving surface 5 of the second piston changes from low pressure to high pressure, i.e. the motion of the second piston 6 changes from a return motion to become an impact motion.

Also other solutions for the drainage of the drive chamber 14b of the recoil piston are possible within the scope of the invention. Thus, the position of the hammer piston can be determined using electronic sensors that identify a position that corresponds to the position E, and a magnetic valve is subsequently operated in order to drain the drive chamber 14b. The sensors can be, for example, of inductive type or of capacitive type. Also electromagnetic radiation, such as light, for example, may be used for detection. It is in this case suitable that the sensor corresponds to the second control means and it can be mounted against the piston housing in order to measure either in the radial direction or in the axial direction. The first control means can be constituted by a groove formed in the hammer piston, an insert that possesses, for example, different magnetic properties, a pattern of stripes, etc. The first control means can, in its simplest form, be constituted by the rear edge or the end surface of the piston.

The forward and reverse motion of the hammer piston can be generated by energy stores, such as energy stored in volumes of oil, that replace the slide valve, instead of being generated by the interaction of the control devices with the slide, as has been described here. This constitutes prior art technology and such devices, known as “slideless” or “valveless” devices are commercially available.

1. A rock drilling device including:
a piston housing,
a first piston movably mounted in the said piston housing and adapted such that it transfers force while in use, principally continuously, directly or indirectly, in the direction of drilling to a drill steel connected to the rock drilling device,
a second piston adapted such that it imposes impacts repetitively while in use, either directly or indirectly, onto the connected drill steel,
a first control device within the piston housing arranged to control, in collaboration with a second control device within the said second piston, a change-over of the pressure of a first portion of a fluid acting on the said second piston,
wherein the rock drilling device has a first control means within the said second piston acting on the said first piston such that it counteracts displacement of the first and second control devices relative to each other at the moment of contact of the second piston onto the drill steel or onto a part connected to this.

2. The rock drilling device according to claim 1, wherein the said first control means is arranged such that it, in collaboration with a second control means that is fixed positioned in or mounted against the piston housing, detects a relative position between the second piston and the piston housing, and such that it at this position changes its action on the said first piston.

3. The rock drilling device according to claim 1, wherein the said relative position is principally achieved at the said moment of impact.

4. The rock drilling device according to claim 1, wherein the first piston is adapted such that it converts, during operation of the rock drilling device, pressure in a second portion of the fluid to a force that acts, principally continuously, in the direction of drilling, either directly or indirectly, on a drill rod connected to the rock drilling device or on a part connected to this rod, and where the said first control means is arranged to reduce the pressure in the second portion of the fluid when the second piston is located in a more advanced position, in the direction towards the drill rod, than the said pre-determined relative position of the first and second control devices.

5. A rock drill rig comprising at least one rock drill device according to claim 1.

6. A method for a rock drilling device comprising:
a piston housing,
a first piston movably mounted in the said piston housing and adapted such that it, during operation of the rock drilling device, converts pressure in a second portion of a fluid into a force that acts, principally continuously, in the direction of drilling, either directly or indirectly, on a drill steel connected to the rock drilling device,
a second piston adapted such that it repetitively imposes impacts in the direction of drilling while in use, either directly or indirectly, on the said drill bit connected to the rock drilling device,
a first control device within the piston housing and a second control device within the said second piston, where these control devices are caused to control, while in interaction with each other, a change-over of the pressure of a first portion of the fluid that acts on a driving surface on the said second piston in order to achieve the said repetitive impacts,
wherein the influence of the said second portion of the fluid on the first piston is caused to be changed at a pre-determined position of the first control device relative to the second control device.

7. The method according to claim 6, wherein a first control means in the second piston causes at a pre-determined position relative to the piston housing the influence of the said second fluid portion on the first piston to be changed.

8. The method according to claim 6, wherein that pre-determined position of the first control means relative to the piston housing is determined by means of a second control means placed within or mounted on the piston housing.

9. The method according to claim 6, wherein the pressure in the second portion of the fluid is being reduced when the second piston is located at a more forward position, in the direction towards the drill steel, than the said pre-determined position of the first control device relative to the second control device.

10. The rock drilling device according to claim 3, wherein the said relative position is principally achieved at the said moment of impact.

11. The rock drilling device according to claim 2, wherein the first piston is adapted such that it converts, during operation of the rock drilling device, pressure in a second portion of the fluid to a force that acts, principally continuously, in the direction of drilling, either directly or indirectly, on a drill rod connected to the rock drilling device or on a part connected to this rod, and where the said first control means is arranged to reduce the pressure in the second portion of the fluid when the second piston is located in a more advanced position, in the direction towards the drill rod, than the said pre-determined relative position of the first and second control devices.

12. The rock drilling device according to claim 3, wherein the first piston is adapted such that it converts, during operation of the rock drilling device, pressure in a second portion of the fluid to a force that acts, principally continuously, in the direction of drilling, either directly or indirectly, on a drill rod connected to the rock drilling device or on a part connected to this rod, and where the said first control means is arranged to reduce the pressure in the second portion of the fluid when the second piston is located in a more advanced position, in the direction towards the drill rod, than the said pre-determined relative position of the first and second control devices.

13. The rock drilling device according to claim 10, wherein the first piston is adapted such that it converts, during operation of the rock drilling device, pressure in a second portion of the fluid to a force that acts, principally continuously, in the direction of drilling, either directly or indirectly, on a drill rod connected to the rock drilling device or on a part connected to this rod, and where the said first control means is arranged to reduce the pressure in the second portion of the fluid when the second piston is located in a more advanced position, in the direction towards the drill rod, than the said pre-determined relative position of the first and second control devices.

14. A rock drill rig comprising at least one rock drill device according to claim 2.

15. A rock drill rig comprising at least one rock drill device according to claim 3.

16. A rock drill rig comprising at least one rock drill device according to claim 4.

17. A rock drill rig comprising at least one rock drill device according to claim 10.

18. A rock drill rig comprising at least one rock drill device according to claim 11.

19. The method according to claim 7, wherein the pressure in the second portion of the fluid is being reduced when the second piston is located at a more forward position, in the direction towards the drill steel, than the said pre-determined position of the first control device relative to the second control device.

20. The method according to claim 8, wherein the pressure in the second portion of the fluid is being reduced when the second piston is located at a more forward position, in the direction towards the drill steel, than the said pre-determined position of the first control device relative to the second control device.
